(19) United States
(12) Patent Application Publication
(10) Pub. No.: US 2022/0126484 A1
(43) Pub. Date: Apr. 28, 2022

(54) OBJECT MANUFACTURING SYSTEM, ASSEMBLING MODULE MAKING METHOD AND OBJECT MANUFACTURING METHOD

(71) Applicant: TING-JUI WANG, New Taipei City (TW)

(72) Inventor: TING-JUI WANG, New Taipei City (TW)

(21) Appl. No.: 17/483,819

(22) Filed: Sep. 24, 2021

(30) Foreign Application Priority Data
Oct. 23, 2020 (TW) 109136977

(51) Int. Cl. B29C 33/30

(52) U.S. Cl. CPC B29C 33/301; B29C 2037/906; B29C 33/305

(57) ABSTRACT

An object manufacturing system, assembling module making method, and object manufacturing method are provided. The object manufacturing system includes an electronic device. The electronic device includes a database, memory module and processor. The database includes at least one assembly encoding information of at least one assembly mold and at least one combination encoding information of at least one combination mold. The memory module includes a process generating module. The processor executes the process generating module and provides at least one process information. The at least one process information includes at least one assembly encoding information of the at least one assembly mold and corresponds to at least one combination encoding information of the at least one combination mold to indicate positions of the at least one combination mold and the at least one assembly mold coupled together, thereby achieving quick assembly.

### CROSS-REFERENCE TO RELATED APPLICATION

This non-provisional application claims priority under 35 U.S.C. § 119(a) on Patent Application No(s).109136977 filed in Taiwan, R.O.C. on Oct. 23, 2020, the entire contents of which are hereby incorporated by reference.

### BACKGROUND OF THE INVENTION

### 1. Field of the Invention

The present disclosure relates to object manufacturing systems, assembling module making methods and object manufacturing methods, and in particular to an object manufacturing system and an object manufacturing method which are based on an assembling module.

### 2. Description of the Related Art

Conventional assembly modules for assembling an object each require multiple assembly apparatuses and manufacturing processes according to required parts and components. As a result, the conventional assembly modules are so bulky and unchangeable that their operations are difficult, thereby leading to low assembly speed.

### BRIEF SUMMARY OF THE INVENTION

An objective of the present disclosure is to provide, in at least one embodiment of the present disclosure, an object manufacturing system, assembling module making method and object manufacturing method are conducive to reduction in the demand for apparatuses and manufacturing processes and thus achieve quick, precise assembly.

To achieve at least the above objective, the present disclosure provides an assembling module making method, the method comprising the steps of: obtaining at least one process information; and generating at least one assembling module by coupling at least one assembly mold and at least one combination mold together according to the at least one process information, wherein the at least one process information comprises the at least one assembly encoding information of at least one assembly mold and the at least one combination encoding information of at least one combination mold corresponding thereto, and the at least one process information indicatives positions of the at least one combination mold and the assembly mold coupled together.

To achieve at least the above objective, the present disclosure further provides an object manufacturing method, the method comprising the steps of: obtaining at least one process information; generating at least one assembling module by coupling at least one assembly mold and at least one combination mold together according to the at least one process information, wherein the at least one process information comprises the at least one assembly encoding information of at least one assembly mold and the at least one combination encoding information of at least one combination mold corresponding thereto, and the at least one process information indicates positions of the at least one combination mold and the assembly mold coupled together; and finalizing an object by fitting a male element and a female element to each other with the at least one assembling module.

To achieve at least the above objective, the present disclosure further provides an object manufacturing system, comprising an electronic device, the electronic device comprising: a database comprising at least one assembly encoding information of at least one assembly mold, at least one combination encoding information of at least one combination mold and at least one process information; a memory module comprising a process generating module; and a processor electrically connected to the database and the memory module and adapted to execute the process generating module and provide the at least one process information, the at least one process information comprising the at least one assembly encoding information of the at least one assembly mold and the at least one combination encoding information of the at least one combination mold, wherein the at least one process information indicates positions of the at least one combination mold and the at least one assembly mold coupled together.

Therefore, the object manufacturing system, assembling module making method and object manufacturing method of the present disclosure provide the required positions of the at least one assembly mold and the at least one combination mold coupled together in accordance with the at least one process information, so as to achieve quick assembly.

### BRIEF DESCRIPTION OF THE DRAWINGS

FIG. 1 is a schematic view of an environment applicable to an object manufacturing system of the present disclosure.

FIG. 2 is a schematic view of a combination of a combination mold and an assembly mold according to an embodiment of the present disclosure.

FIG. 3 is a schematic view of another combination of a combination mold and an assembly mold according to an embodiment of the present disclosure.

FIG. 4 is a schematic view of use of the combination mold and the assembly mold according to an embodiment of the present disclosure.

FIG. 5 is a block diagram of an electronic device according to an embodiment of the present disclosure.

FIG. 6 is another block diagram of the electronic device according to an embodiment of the present disclosure.

FIG. 7 is a schematic view of a process flow of an object manufacturing method according to an embodiment of the present disclosure.

FIG. 8 is a schematic view of another process flow of the object manufacturing method according to an embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

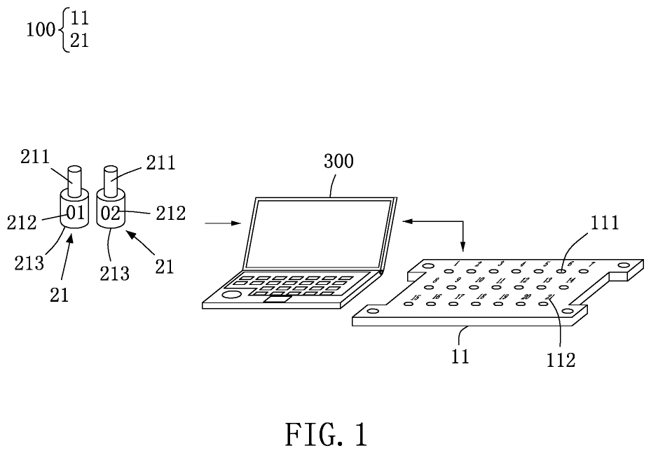

Referring to FIG. 1, there is shown a schematic view of an environment applicable to an object manufacturing system of the present disclosure. The object manufacturing system comprises an assembling module 100 and an electronic device 300. The assembling module 100 comprises a first assembly mold 11 and at least one first combination mold 21. The assembling module 100 uses the first assembly mold 11 and the first combination mold 21 to fit together a male element and a female element in order to manufacture a required object. The electronic device 300 provides a process information. The process information comprises an assembly encoding information 112 (for example, numerals, text or symbols) of the first assembly mold 11 and a combination encoding information 212 (for example, numerals, text or symbols) of the first combination mold 21 corresponding thereto to indicate the positions of the first combination mold 21 and the first assembly mold 11 coupled together.

The positions of the first combination mold 21 and the first assembly mold 11 coupled together can be definitely indicated by the process information, and thus the first combination mold 21 and the first assembly mold 11 can be quickly positioned and coupled together to reduce the chance of mismatch therebetween and achieve quick, precise assembly.

The first assembly mold 11 comprises a plurality of first matching portions 111. The position of each first matching portion 111 on the first assembly mold 11 is defined by matching each first matching portion 111 to an assembly encoding information 112 (01˜21 shown in FIG. 1). For the same first assembly mold 11, the assembly encoding information 112 varies from first matching portion 111 to first matching portion 111. The first matching portions 111 are arranged in a matrix and disposed on the first assembly mold 11. The first matching portions 111 are each of a bump structure, dent structure, screw structure, snap-engagement structure or magnetic suction structure.

Each first combination mold 21 comprises at least one first mating portion 211 and first mounting portion 213. Each first mating portion 211 corresponds in position to a combination encoding information 212 (for example, 01, 02 shown in FIG. 1). In the embodiment where the first combination mold 21 comprises a plurality of first mating portions 211, the combination encoding information 212 for the same first combination mold 21 varies from first mating portion 211 to first mating portion 211. The first mating portions 211 are each of a bump structure, dent structure, screw structure, snap-engagement structure or magnetic suction structure. The first mounting portion 213 is of a planar structure, bump structure, dent structure, rotatable structure or heating structure.

Therefore, when the first mating portion 211 of the first combination mold 21 and the first matching portions 111 of the first assembly mold 11 are coupled together, their positions can be indicated by the corresponding assembly encoding information 112 and combination encoding information 212. Thus, the first mating portion 211 of the first combination mold 21 and the first matching portion 111 of the first assembly mold 11 can be quickly positioned and coupled together to thereby reduce the chance of mismatch therebetween and achieve quick, precise assembly.

In an embodiment, the electronic device 300 is a computer. For example, the electronic device 300 is a laptop, desktop, or tablet, but the present disclosure is not limited thereto.

In an embodiment, the assembly encoding information 112 is a numeral or a graphic code, and the combination encoding information 212 is a numeral or a graphic code, but the present disclosure is not limited thereto.

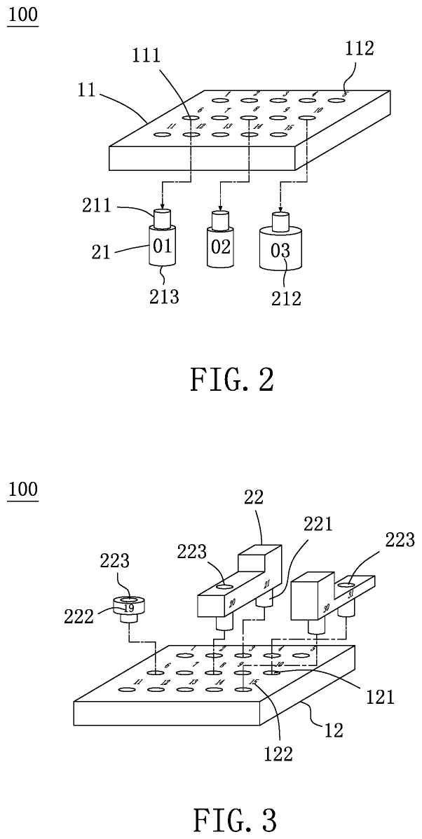

The relationship between the first assembly mold 11 and the first combination mold 21 is illustrated with FIG. 2 and Table 1. In this embodiment, the first assembly mold 11 comprises a plurality of first matching portions 111. Each first matching portion 111 corresponds in position to an assembly encoding information 112 (for example, 01˜15 shown in FIG. 2). The assembly encoding information 112 varies from first matching portion 111 to first matching portion 111. In this embodiment, each combination mold 21 comprises a first mating portion 211. Each first mating portion 211 corresponds in position to a combination encoding information 212 (for example, 01, 02, 03 shown in FIG. 2). The combination encoding information 212 varies from first mating portion 211 to first mating portion 211.

Referring to Table 1 below, Table 1 illustrates an embodiment of the process information, but the present disclosure is not limited thereto.

TABLE 1

| assembly | combination |
|---|---|
| encoding | encoding |
| information | information |
| 06 | 01 |
| 08 | 02 |
| 10 | 03 |

The process information indicates the positions of the first combination mold 21 and the first assembly mold 11 coupled together. Referring to Table 1, the process information indicates the following: the first mating portion 211 associated with the combination encoding information 212 being 01 corresponds in position to and is combined with the first matching portions 111 of the assembly encoding information 11206; the first mating portion 211 associated with the combination encoding information 212 being 02 corresponds in position to and is combined with the first matching portions 111 of the assembly encoding information 11208; and the first mating portion 211 associated with the combination encoding information 212 being 03 corresponds in position to and is combined with the first matching portions 111 of the assembly encoding information 11210. Thus, the combinational relationships between the first assembly mold 11 and each first combination mold 21 are indicated by the process information quickly to enhance the precision of positioning or replacing the first combination molds 21 on the first assembly mold 11 and thereby achieve quick, precise assembly.

Referring to FIG. 3 and Table 2, the assembling module 100 in another embodiment illustrated by FIG. 3 comprises a second assembly mold 12 and at least one second combination mold 22. In this embodiment, the second assembly mold 12 and the first assembly mold 11 each comprise a plurality of second matching portions 121. Each second matching portion 121 corresponds in position to an assembly encoding information 122. For the same second assembly mold 12, the assembly encoding information 122 varies from second matching portion 121 to second matching portion 121. The second matching portions 121 are arranged in a matrix and disposed on the second assembly mold 12. The second matching portions 121 are each of a bump structure, dent structure, screw structure, snap-engagement structure or magnetic suction structure. Each second combination mold 22 comprises at least one second mating portion 221 and second mounting portion 223. Each second mating portion 221 corresponds in position to a combination encoding information 222 (for example, 19, 20, 21, 30, 31 shown in FIG. 3). In the embodiment where the second combination mold 22 comprises a plurality of second mating portions 221, whereas the combination encoding information 222 for the same second combination mold 22 varies from second mating portion 221 to second mating portion 221. The second mating portion 221 is of a bump structure, dent structure, screw structure, snap-engagement structure or magnetic suction structure. The second mounting portion 223 is of a planar structure, bump structure, dent structure, rotatable structure or heating structure.

Referring to Table 2 below, Table 2 illustrates another embodiment of the process information, and the present disclosure is not limited thereto.

| assembly | combination |
|---|---|
| encoding | encoding |
| information | information |
| 6 | 19 |
| 8 | 20 |
| 3 | 21 |
| 15 | 30 |
| 10 | 31 |

In the embodiment illustrated by Table 2, the process information indicates the following: the second mating portion 221 associated with the combination encoding information 222 being 9 corresponds in position to and is combined with the second matching portions 121 of the assembly encoding information 1226; the second mating portion 221 associated with the combination encoding information 222 being 20 corresponds in position to and is combined with the second matching portions 121 of the assembly encoding information 1128; the second mating portion 221 associated with the combination encoding information 222 being 21 corresponds in position to and is combined with the second matching portions 121 of the assembly encoding information 1223; the second mating portion 221 associated with the combination encoding information 222 being 30 corresponds in position to and is combined with the second matching portions 121 of the assembly encoding information 12215; and the second mating portion 221 associated with the combination encoding information 222 being 31 corresponds in position to and is combined with the second matching portions 121 of the assembly encoding information 12210. In this embodiment, one second combination mold 22 comprises a plurality of second mating portions 221, but the present disclosure is not limited thereto.

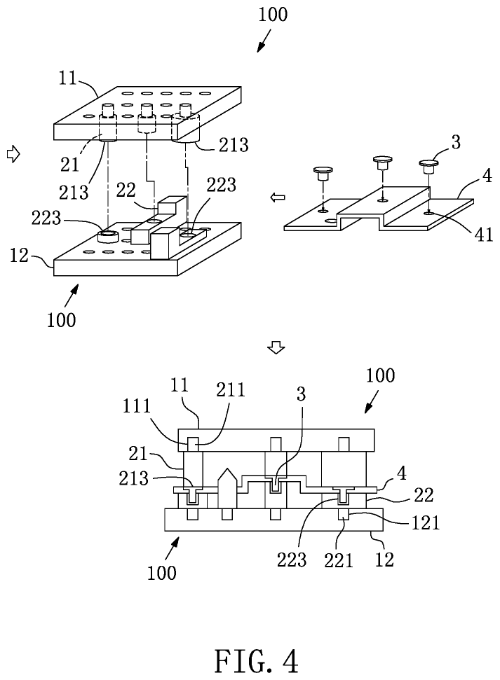

Referring to FIG. 4, the assembling module 100 is illustrated with the first assembly mold 11, the first combination mold 21, the second assembly mold 12, and the second combination mold 22 shown in FIG. 2 and FIG. 3.

The first assembly mold 11 and first combination mold 21 are coupled together as shown in FIG. 2 to form the upper mold. The second assembly mold 12 and the second combination mold 22 are coupled together as shown in FIG. 4 to form the lower mold. A plurality of male elements 3 correspond in position to the first mounting portions 213 (for example, planar structure) of the first combination mold 21. A plurality of assembly portions 41 of the female element 4 correspond in position to the second mounting portions 223 (for example, dent structure) of the second combination mold 22. The male elements 3 are each disposed between the corresponding first combination mold 21 and the corresponding female element 4 and correspond in position to the corresponding assembly portion 41, so as to be coupled to the corresponding assembly portion 41. Therefore, the upper mold and the lower mold are near to each other, such that the first combination mold 21 exerts a force on the male elements 3 from above, causing the male elements 3 to get coupled to the assembly portions 41 of the female elements 4 to form objects, respectively.

In an embodiment, the upper mold or the lower mold takes any other forms, and thus the present disclosure is not limited thereto. For example, the male element 3 and the female element 4 may also be disposed between the first assembly mold 11 and the lower mold, and a force may also be exerted on the male element 3 to enable the male element 3 to be coupled to the female element 4. Alternatively, the male element 3 and the female element 4 are disposed between the upper mold and the second assembly mold 12, and a force is exerted on the male element to enable the male element to be coupled to the female element.

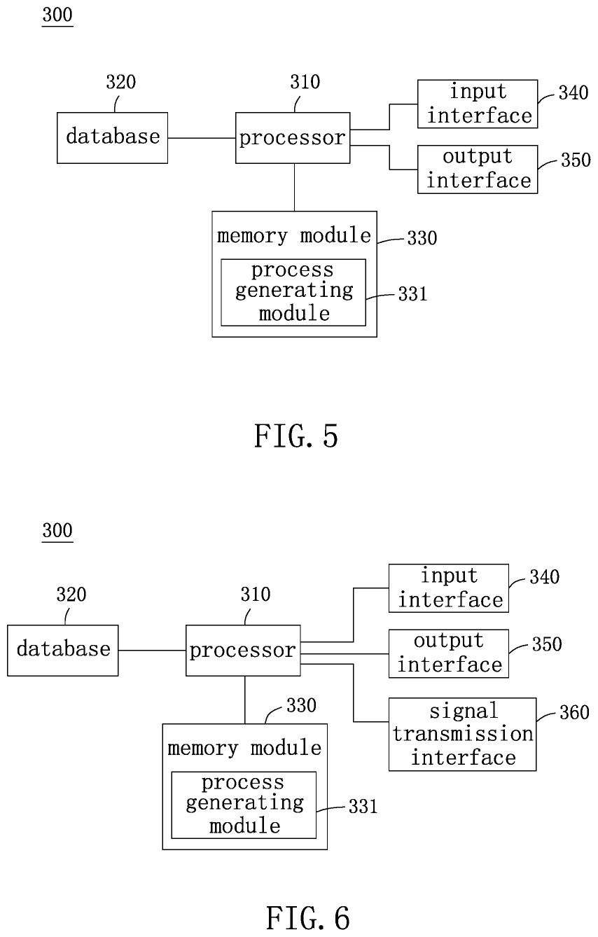

Referring to FIG. 5, the electronic device 300 at least comprises a processor 310, database 320, memory module 330, input interface 340 and output interface 350. The processor 310 is electrically connected to the database 320, the memory module 330, the input interface 340 and the output interface 350.

The database 320 stores information required for operation of the electronic device 300 and comprises assembly encoding informations 112, 122 of at least one assembly mold (first assembly mold 11, second assembly mold 12), combination encoding informations 212, 222 of at least one combination mold (first combination mold 21, second combination mold 22), and at least one process information.

The memory module 330 stores a program required for operation of the electronic device 300 and comprises a process generating module 331 for generating the process information.

The input interface 340 receives operation instructions inputted by users of the electronic device 300. The output interface 350 provides the process information.

The processor 310 executes the process generating module 331 to access the at least one assembly encoding information 112 of the first assembly mold 11, the at least one combination encoding information 212 of the first combination mold 21, and the at least one process information in the database 320. The at least one assembly encoding information 112 and the at least one combination encoding information 212 in the at least one process information indicate the positions of the first combination mold 21 and the first assembly mold 11 coupled together.

Thus, the combination molds 21, 22 can be quickly, precisely positioned or replaced to achieve quick, precise assembly.

In an embodiment, the processor 310 executes the process generating module 331 according to the operation instructions, retrieves from the database 320 at least one assembly encoding information 112 (or assembly encoding information 122) of the first assembly mold 11 (or second assembly mold 12) and the at least one combination encoding information 212 (or combination encoding information 222) of the first combination mold 21 (or second combination mold 22), and selects the at least one assembly encoding information 112 (or assembly encoding information 122) and the at least one combination encoding information 212 (or combination encoding information 222) according to the operation instructions to generate the process information.

In an embodiment, the processor 310 reads the process information stored in the database 320 according to the operation instructions. Therefore, users can quickly select and use the process information and quickly couple the first assembly mold 11 and the first combination mold 21 (or the second assembly mold 12 and the second combination mold 22) together according to the process information.

The processor 310 enables the output interface 350 to provide the process information.

The electronic device 300 further comprises at least one signal transmission interface 360 (shown in FIG. 6). The processor 310 enables the process information to be transmitted to an automated device through the at least one signal transmission interface 360, such that the automated device enables the first assembly mold 11 and the first combination mold 21 (or the second assembly mold 12 and the second combination mold 22) to be coupled together according to the process information.

Thus, the present disclosure provides the electronic device 300 which is suitable for use with an assembling module and is adapted to provide the process information, such that the combination molds 21, 22 can be quickly, precisely positioned or replaced to achieve quick, precise assembly.

In an embodiment, the database 320 and the memory module 330 are provided in the form of memory cards, hard disk drives and/or memory, but the present disclosure is not limited thereto.

In an embodiment, the input interface 340 is provided in the form of a mouse, keyboard, microphone or touch panel, but the present disclosure is not limited thereto.

In an embodiment, the output interface 350 is a display screen, projection screen or VR visual device, but the present disclosure is not limited thereto.

In an embodiment, the at least one signal transmission interface 360 is a wireless communication interface or a wired communication interface, but the present disclosure is not limited thereto.

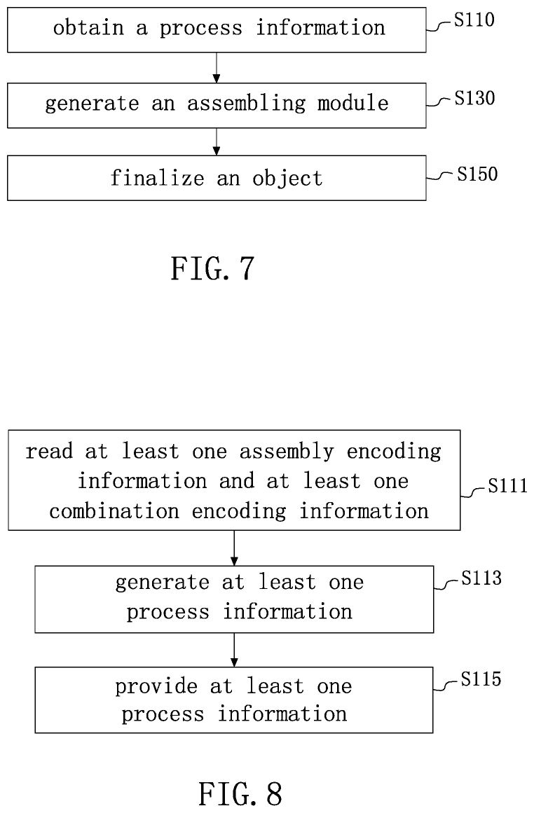

Referring to FIG. 7, an assembling module making method based on the aforesaid preferred embodiments is provided by the present disclosure, and its steps are described below.

Step S110: obtaining a process information. The process information is fetched with the electronic device 300.

Step S130: generating an assembling module. In this embodiment, at least one assembly mold and at least one combination mold are coupled together according to the process information to form at least one assembling module, with the assembling module corresponding in position to an object male element 3 or corresponding in position to an object female element 4. The at least one process information comprises the at least one assembly encoding information of at least one assembly mold and corresponds in position to the at least one combination encoding information of at least one combination mold. Thus, the process information is effective in definitely indicating the positions of the at least one combination mold and the assembly mold coupled together.

In an embodiment, the step S130 further comprises coupling a first assembly mold 11 and at least one first combination mold 21 together according to the process information to form an upper mold or coupling a second assembly mold 12 and at least one second combination mold 22 together according to the process information to form a lower mold. Thus, the process information corresponds to one or more assembling modules.

Step S150: finalizing an object. The assembling module enables the male element 3 and female element 4 to be coupled together under a force, so as to finalize the object.

In an embodiment, the step S150 further involves allowing the male element 3 and the female element 4 to be aligned with the upper mold and the lower mold and thus disposed between the upper mold and the lower mold, and allowing the male element 3 to be coupled to the female element 4 under a force. In the embodiment, the object is manufactured with a plurality of assembling modules. Alternatively, the male element 3 and the female element 4 are disposed between the first assembly mold 11 and the lower mold, and a force is exerted on the male element 3 to enable the male element 3 to be coupled to the female element 4. Alternatively, the male element 3 and the female element 4 are disposed between the upper mold and the second assembly mold 12, and a force is exerted on the male element 3 to enable the male element 3 to be coupled to the female element 4.

Step S110 further comprises the sub-steps shown in FIG. 8 and described below.

Step S111 involves reading at least one assembly encoding information and at least one combination encoding information. In this embodiment, as shown in FIG. 5 or FIG. 6, the processor 310 executes the process generating module 331, reads at least one assembly encoding information 112, 122, at least one combination encoding information 212, 222 in the database 320, and/or reads the process information, including at least one assembly encoding information 112, 122 and at least one combination encoding information 212, 222, in the database 320.

Step S113 involves generating at least one process information. In this embodiment, as shown in FIG. 5 or FIG. 6, the processor 310 executes the process generating module 331 and selects at least one assembly encoding information 112, 122 and the at least one combination encoding information 212, 222 corresponding thereto according to operation instructions inputted by users so as to generate the process information. In another embodiment, the processor 310 reads, according to the operation instructions, the process information stored in the database 320 so as to generate the at least one process information.

Step S115 involves providing at least one process information. In this embodiment, as shown in FIG. 5 or FIG. 6, the processor 310 executes the process generating module 331 and provides the process information through the output interface 350. In an embodiment, the processor 310 executes the process generating module 331 and provides the process information to an automated apparatus through the signal transmission interface 360.

Thus, given the process information provided with an object manufacturing method of the present disclosure, the first combination mold 21 (or the second combination mold 22) is quickly, precisely positioned or replaced to achieve quick, precise assembly.

In conclusion, embodiments of the present disclosure provide an object manufacturing system, assembling module making method and object manufacturing method. According to the present disclosure, an object manufacturing method, assembling module making method and object manufacturing system are effective in allowing combination molds to be quickly, precisely positioned or replaced according to the process information to effectively increase the speed and precision of the combination of the combination molds 21, 22 and assembly molds 11, 12 and thereby achieve the objective of assembly quickly and precisely. In addition, the assembling module is attained by modularization to not only implement multiple processes through arrangement of multiple combination molds but also greatly enhance the ease of changing the assembling module as well as the flexibility and ease of its application.

While the present disclosure has been described by means of specific embodiments, numerous modifications and variations could be made thereto by those skilled in the art without departing from the scope and spirit of the present disclosure set forth in the claims.

What is claimed is:

1. An assembling module making method, the method comprising the steps of:
obtaining at least one process information; and
generating at least one assembling module by coupling at least one assembly mold and at least one combination mold together according to the at least one process information, wherein the at least one process information comprises the at least one assembly encoding information of at least one assembly mold and the at least one combination encoding information of at least one combination mold corresponding thereto, and the at least one process information indicatives positions of the at least one combination mold and the assembly mold coupled together.

2. An object manufacturing method, the method comprising the steps of:
obtaining at least one process information;
generating at least one assembling module by coupling at least one assembly mold and at least one combination mold together according to the at least one process information, wherein the at least one process information comprises the at least one assembly encoding information of at least one assembly mold and the at least one combination encoding information of at least one combination mold corresponding thereto, and the at least one process information indicates positions of the at least one combination mold and the assembly mold coupled together; and
finalizing an object by fitting a male element and a female element to each other with the at least one assembling module.

3. The method of claim 1, wherein the step of generating at least one assembling module further comprises coupling a first assembly mold and at least one first combination mold together to from an upper mold according to the at least one process information or coupling a second assembly mold and at least one second combination mold together to from a lower mold according to the at least one process information.

4. The method of claim 2, wherein the step of generating at least one assembling module further comprises coupling a first assembly mold and at least one first combination mold together to form an upper mold according to the at least one process information or coupling a second assembly mold and at least one second combination mold together to form a lower mold according to the at least one process information.

5. The method of claim 4, wherein the step of finalizing an object further comprises positioning the male element and the female element between the first assembly mold and the lower mold and exerting a force on the male element to enable the male element to be coupled to the female element.

6. The method of claim 4, wherein the step of finalizing an object further comprises positioning the male element and the female element between the upper mold and the second assembly mold and exerting a force on the male element to enable the male element to be coupled to the female element.

7. The method of claim 4, wherein the step of finalizing an object further comprises positioning the male element and the female element between the upper mold and the lower mold and exerting a force on the male element to enable the male element to be coupled to the female element.

8. The method of claim 1, wherein the step of obtaining at least one process information further comprises generating the at least one process information and providing the at least one process information, wherein the at least one process information comprises the at least one assembly encoding information of at least one assembly mold and the at least one combination encoding information of at least one combination mold corresponding thereto, and the at least one process information indicates positions of the at least one combination mold and the assembly mold coupled together.

9. The method of claim 2, wherein the step of obtaining at least one process information further comprises generating the at least one process information and providing the at least one process information, wherein the at least one process information comprises the at least one assembly encoding information of at least one assembly mold and the at least one combination encoding information of at least one combination mold corresponding thereto, and the at least one process information indicates positions of the at least one combination mold and the assembly mold coupled together.

10. The method of claim 8, wherein the step of generating at least one process information further comprises generating the at least one process information according to the at least one assembly encoding information of the at least one assembly mold selected and the at least one combination encoding information of the at least one combination mold.

11. The method of claim 9, wherein the step of generating at least one process information further comprises generating the at least one process information according to the at least one assembly encoding information of the at least one assembly mold selected and the at least one combination encoding information of the at least one combination mold.

12. The method of claim 8, wherein the step of generating at least one process information further comprises reading at least one process information stored to generate the at least one process information.

13. The method of claim 9, wherein the step of generating at least one process information further comprises reading at least one process information stored to generate the at least one process information.

14. The method of claim 1, wherein the at least one assembly encoding information is a numeral or a graphic code, and the at least one combination encoding information is a numeral or a graphic code.

15. The method of claim 2, wherein the at least one assembly encoding information is a numeral or a graphic code, and the at least one combination encoding information is a numeral or a graphic code.

16. The method of claim 1, wherein the at least one assembly mold comprises a plurality of matching portions, and the at least one combination mold comprises at least one mating portion, the matching portions each corresponding to the assembly encoding information marked on the at least one assembly mold, and each said mating portion corresponding to the combination encoding information marked on the at least one combination mold, wherein the at least one mating portion is coupled to the matching portions.

17. The method of claim 2, wherein the at least one assembly mold comprises a plurality of matching portions, and the at least one combination mold comprises at least one mating portion, the matching portions each corresponding to the assembly encoding information marked on the at least one assembly mold, and each said mating portion corresponding to the combination encoding information marked on the at least one combination mold, wherein the at least one mating portion is coupled to the matching portions.

18. The method of claim 16, wherein the matching portions are arranged in a matrix.

19. The method of claim 17, wherein the matching portions are arranged in a matrix.

20. The method of claim 1, wherein the assembling module corresponds in position to an object male element or corresponds in position to an object female element.

21. An object manufacturing system, comprising an electronic device, the electronic device comprising:
a database comprising at least one assembly encoding information of at least one assembly mold, at least one combination encoding information of at least one combination mold and at least one process information;
a memory module comprising a process generating module; and
a processor electrically connected to the database and the memory module and adapted to execute the process generating module and provide the at least one process information, the at least one process information comprising the at least one assembly encoding information of the at least one assembly mold and the at least one combination encoding information of the at least one combination mold, wherein the at least one process information indicates positions of the at least one combination mold and the at least one assembly mold coupled together.

22. The system of claim 21, wherein the electronic device is a computer.

23. The system of claim 21, wherein the at least one assembly encoding information is a numeral or a graphic code, and the at least one combination encoding information is a numeral or a graphic code.

24. The system of claim 21, wherein the at least one assembly mold comprises a plurality of matching portions, and the at least one combination mold comprises at least one mating portion, the matching portions each corresponding in position to the assembly encoding information marked on the at least one assembly mold, and each said mating portion corresponding in position to the combination encoding information marked on the at least one combination mold, wherein the at least one mating portion is coupled to the matching portions.

25. The system of claim 24, wherein the matching portions are arranged in a matrix.

26. The system of claim 21, wherein the electronic device further comprises an input interface or an output interface, the input interface being a mouse, keyboard, microphone or touch panel, and the output interface being a display screen, projection screen or VR visual device.
